(19) United States
(12) Patent Application Publication
(10) Pub. No.: US 2026/0267030 A1
(43) Pub. Date: Sep. 10, 2026

(54) METHOD, EQUIPMENT AND MEDIUM FOR LINEAR ENGINEERING GEOLOGICAL TRIDIMENSIONAL ZONING

(71) Applicant: Institute of Geology and Geophysics, CAS, Beijing (CN)

(72) Inventors: Bowen ZHENG, Beijing (CN); Zifang ZHU, Beijing (CN); Shengwen QI, Beijing (CN); Yue YANG, Beijing (CN); Guoxiang YANG, Beijing (CN); Yongshuang ZHANG, Beijing (CN); Songfeng GUO, Beijing (CN); Fan SONG, Beijing (CN); Yongchao LI, Beijing (CN); Ning LIANG, Beijing (CN); Yu ZOU, Beijing (CN); Jianing CONG, Beijing (CN); Yiwen QIN, Beijing (CN); Gaoang WEI, Beijing (CN); Chao JIN, Beijing (CN); Jingjing YING, Beijing (CN); Tao WANG, Beijing (CN); Xinyi GUO, Beijing (CN); Xiao LU, Beijing (CN); Fengjiao TANG, Beijing (CN)

(21) Appl. No.: 19/467,367

(22) Filed: Feb. 2, 2026

(30) Foreign Application Priority Data
Feb. 27, 2025 (CN) 202510220183.6

(51) Int. Cl. G01V 20/00; G01V 1/00; G01V 1/30

(52) U.S. Cl. CPC G01V 20/00; G01V 1/003; G01V 1/301

(57) ABSTRACT

A method, an equipment and a medium for linear engineering geological tridimensional zoning are disclosed by the present disclosure, which relate to the field of rock engineering geomechanics. The method includes: the working area undergoes plane engineering geological zoning to obtain a preliminary plane engineering geological zoning result; the preliminary plane engineering geological zoning result is optimized to obtain a final plane engineering geological zoning result; the working area undergoes profile engineering geological zoning to obtain a preliminary profile engineering geological zoning result; the preliminary profile engineering geological zoning result is optimized to obtain a final profile engineering geological zoning result; and the final plane engineering geological zoning result is combined with the final profile engineering geological zoning result to obtain a linear engineering geological tridimensional zoning image.

### CROSS-REFERENCE TO RELATED APPLICATION

This patent application claims the benefit and priority of Chinese Patent Application No. 202510220183.6, entitled “METHOD, EQUIPMENT AND MEDIUM FOR LINEAR ENGINEERING GEOLOGICAL TRIDIMENSIONAL ZONING” filed with the China National Intellectual Property Administration on Feb. 27, 2025, the disclosure of which is incorporated by reference herein in its entirety as part of the present application.

### TECHNICAL FIELD

The present disclosure relates to the technical field of rock engineering geomechanics, in particular to a method, an equipment and a medium for linear engineering geological tridimensional zoning.

### BACKGROUND

Engineering geological zoning is a process of zoning and segmenting the working area according to the requirements of different stages of engineering construction and the principle of similar engineering geological conditions and similar engineering geological problems. In recent years, the planning, the design and the construction of linear projects such as railways and highways in China that take into account the layout of both surface engineering and underground engineering are gradually being carried out, especially in the complex geological environment, the safety and the stability of engineering geology are very important.

However, there are many engineering geological plane zoning indexes and engineering geological profile zoning indexes of the long and large linear project in complex mountain region, and the data of zoning indexes are difficult to obtain, which restricts the efficiency of the engineering geological zoning work and the accuracy of the zoning results of the long and large linear project in complex mountain region. It is urgent to select the key indexes of the engineering geological plane zoning and the engineering geological profile zoning of the long and large linear project in complex mountain region and establish the optimization index system respectively. However, there is no effective method for optimizing the key indexes of the engineering geological zoning, and the prior art does not involve the development of the engineering geological tridimensional zoning.

### SUMMARY

The objective of the present disclosure is to provide a method, an equipment and a medium for linear engineering geological tridimensional zoning, which can carry out the engineering geological tridimensional zoning and improve the efficiency of the engineering geological zoning work and the accuracy of the zoning results of the linear project.

In order to achieve the above objectives, the present disclosure adopts the following technical solutions.

In a first aspect, the present disclosure provides a method for linear engineering geological tridimensional zoning, which includes the following steps.

The working area undergoes plane engineering geological zoning to obtain a preliminary plane engineering geological zoning result; where the preliminary plane engineering geological zoning result is a result obtained based on a plane zoning index.

The preliminary plane engineering geological zoning result is optimized to obtain a final plane engineering geological zoning result.

The working area undergoes profile engineering geological zoning to obtain a preliminary profile engineering geological zoning result; where the preliminary profile engineering geological zoning result is a result obtained based on a profile zoning index.

The preliminary profile engineering geological zoning result is optimized to obtain a final profile engineering geological zoning result.

The final plane engineering geological zoning result and the final profile engineering geological zoning result are combined to obtain a linear engineering geological tridimensional zoning image.

In a second aspect, the present disclosure provides a computer equipment, including: a memory, a processor, and a computer program stored in the memory and executable on the processor, the processor executes the computer program to implement the method for linear engineering geological tridimensional zoning described above.

In a third aspect, the present disclosure provides a computer readable storage medium, on which a computer program is stored, and when the computer program is executed by a processor, the method for linear engineering geological tridimensional zoning described above is realized.

According to the specific embodiment provided by the present disclosure, the present disclosure discloses the following technical effects.

The present disclosure provides a method, an equipment and a medium for linear engineering geological tridimensional zoning, the method includes: the working area undergoes plane engineering geological zoning to obtain a preliminary plane engineering geological zoning result, where the preliminary plane engineering geological zoning result is a result obtained based on a plane zoning index; the preliminary plane engineering geological zoning result is optimized to obtain a final plane engineering geological zoning result; the working area undergoes profile engineering geological zoning to obtain a preliminary profile engineering geological zoning result, where the preliminary profile engineering geological zoning result is a result obtained based on a profile zoning index; the preliminary profile engineering geological zoning result is optimized to obtain a final profile engineering geological zoning result; and the final plane engineering geological zoning result is combined with the final profile engineering geological zoning result to obtain a linear engineering geological tridimensional zoning image. Based on the linear engineering geological tridimensional zoning image, the tridimensional results of different grades of engineering geological conditions can be quantitatively characterized, and the tridimensional areas of different grades of engineering geological conditions can be visually presented. The engineering geological tridimensional zoning result can be used to guide linear engineering to give preference to the tridimensional areas with high quality engineering geological conditions for route planning, and to avoid the tridimensional areas with low quality engineering geological conditions as much as possible, thereby determining the site selection and layout of linear engineering in the tridimensional areas above and below the ground. The present disclosure optimizes the plane engineering geological zoning result and the profile engineering geological zoning result, and integrates them to form the linear engineering geological tridimensional zoning image, and the disaster-pregnant background of the linear engineering geological problem and the control effect of the disaster-pregnant background on the engineering geological condition can be more intuitively known, so that the prevention and control of linear engineering geological risks considering the layout of both the surface engineering and the underground engineering can be scientifically guided.

### BRIEF DESCRIPTION OF THE DRAWINGS

In order to more clearly illustrate the embodiments of the present disclosure or technical solutions in the related art, the accompanying drawings used in the embodiments will now be described briefly. It is obvious that the drawings in the following description are only some embodiments of the present disclosure, and that those skilled in the art can obtain other drawings from these drawings without any creative efforts.

FIG. 1 is an application environment diagram of a method for linear engineering geological tridimensional zoning in an embodiment of the present disclosure;

FIG. 2 is a flowchart of a method for linear engineering geological tridimensional zoning provided by an embodiment of the present disclosure;

FIG. 3 is an overall flowchart of a method for linear engineering geological tridimensional zoning provided by an embodiment of the present disclosure; and

FIG. 4 is structure diagram of computer equipment provided in an embodiment of the present disclosure.

### DETAILED DESCRIPTION OF THE EMBODIMENTS

In the following, the technical solutions in the embodiments of the present disclosure will be clearly and completely described in conjunction with the accompanying drawings in the embodiments of the present disclosure. Obviously, the described embodiments are only a part of the embodiments of the present disclosure, but not all the embodiments thereof. Based on the embodiments of the present disclosure, all other embodiments obtained by those skilled in the art without any creative efforts shall fall within the scope of the present disclosure.

In order to make the above objectives, features, and advantages of the present disclosure more obvious and understandable, the following will provide further detailed explanations of the present disclosure in conjunction with the accompanying drawings and specific embodiments.

The development of the engineering geological tridimensional zoning, which simultaneously considers the zoning evaluation of the plane engineering geological conditions of the surface engineering and the segmented evaluation of profile engineering geological conditions of the underground engineering, can provide the engineering geological basis for the planning, the design and the construction of linear projects with the layout of both surface engineering and underground engineering, so as to effectively prevent and control potential geological disasters and ensure the safety and smooth progress of the engineering construction.

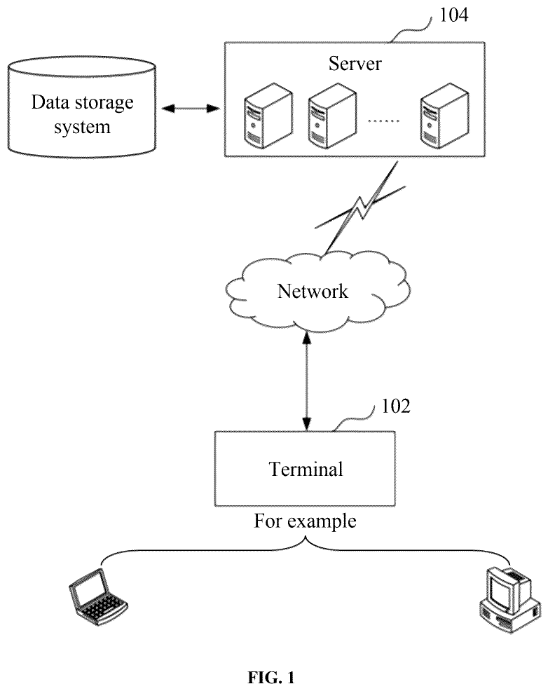

The method for linear engineering geological tridimensional zoning provided by an embodiment of the present disclosure can be applied to the application environment shown in FIG. 1. Wherein, the terminal 102 communicates with the server 104 through the network. The data storage system can store the data that the server 104 needs to process. The data storage system can be set up separately, integrated on the server 104, or placed on the cloud or other servers. The terminal 102 may send the working area to the server 104, and after the server 104 receives the working area, the server 104 executes the following method: the working area undergoes plane engineering geological zoning to obtain a preliminary plane engineering geological zoning result, wherein the preliminary plane engineering geological zoning result is a result obtained based on a plane zoning index; the preliminary plane engineering geological zoning result is optimized to obtain a final plane engineering geological zoning result; the working area undergoes profile engineering geological zoning to obtain a preliminary profile engineering geological zoning result, wherein the preliminary profile engineering geological zoning result is a result obtained based on a profile zoning index; the preliminary profile engineering geological zoning result is optimized to obtain a final profile engineering geological zoning result; and the final plane engineering geological zoning result is combined with the final profile engineering geological zoning result to obtain a linear engineering geological tridimensional zoning image. The server 104 may feed back the obtained linear engineering geological tridimensional zoning image to the terminal 102. In addition, in some embodiments, the linear engineering geological tridimensional zoning method can also be separately implemented by the server 104 or the terminal 102. For example, the terminal 102 can directly perform linear engineering geological tridimensional zoning on the working area, or the server 104 can obtain the working area from the data storage system and perform the linear engineering geological tridimensional zoning on the working area.

Wherein, the terminal 102 may be, but is not limited to, a variety of desktop computers, laptops, smartphones, and tablets. The server 104 may be implemented by an independent server or a server cluster including a plurality of servers, and may also be a cloud server.

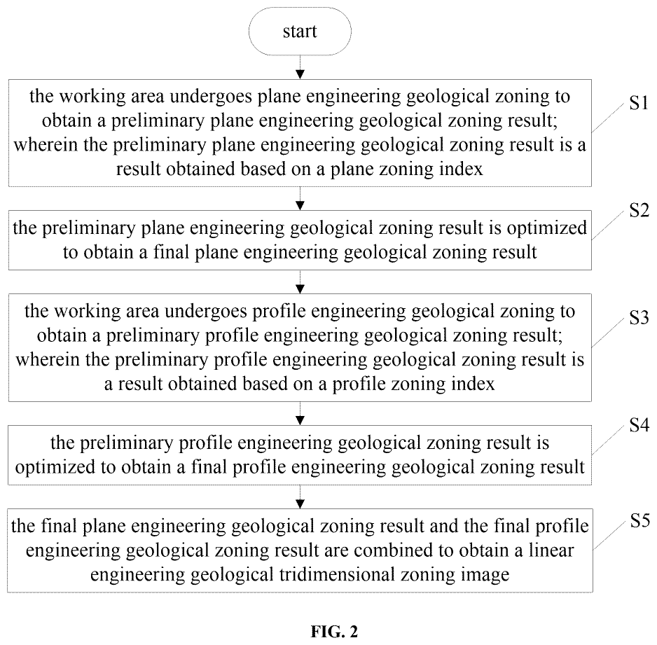

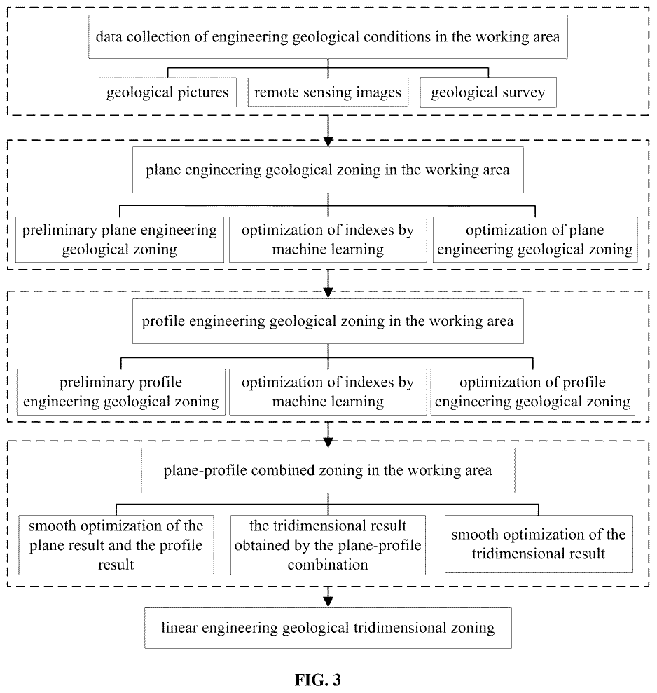

In an exemplary embodiment, as shown in FIG. 2 and FIG. 3, a method for linear engineering geological tridimensional zoning is provided, and the method is executed by a computer equipment, specifically, the method can be executed by a computer equipment such as a terminal or a server independently, and can also be executed by a terminal and a server together. The method is applied to the server 104 in FIG. 1 as an example, and includes the following step S1 to step S5.

S1: the working area undergoes plane engineering geological zoning to obtain a preliminary plane engineering geological zoning result; wherein the preliminary plane engineering geological zoning result is a result obtained based on a plane zoning index.

S2: the preliminary plane engineering geological zoning result is optimized to obtain a final plane engineering geological zoning result.

S3: the working area undergoes profile engineering geological zoning to obtain a preliminary profile engineering geological zoning result; wherein the preliminary profile engineering geological zoning result is a result obtained based on a profile zoning index.

S4: the preliminary profile engineering geological zoning result is optimized to obtain a final profile engineering geological zoning result.

S5: the final plane engineering geological zoning result and the final profile engineering geological zoning result are combined to obtain a linear engineering geological tridimensional zoning image.

By implementing the above step S1 to step S5, the engineering geological tridimensional zoning can be carried out, and the efficiency of the engineering geological zoning work and the accuracy of the zoning result of the linear project are improved.

As an optional embodiment, step S1 specifically includes the following contents.

S11: the engineering geological condition data of the working area are acquired, wherein the engineering geological condition data of the working area include geological pictures, remote sensing images and geological survey information.

S12: the plane zoning indexes are determined according to the engineering geological condition data of the working area.

S13: the working area is divided into grids to obtain a plurality of first grid units with the same size; wherein each first grid unit has a numerical value corresponding to the plane zoning index.

S14: each first grid unit is standardized to obtain a standardized first unit.

S15: the first correlation between the various plane zoning indexes in the standardized first unit is determined based on the Pearson correlation coefficient in the SPSS software.

S16: the plane zoning indexes with the first correlation greater than the first preset threshold are taken as preliminary screening plane zoning indexes.

S17: the comprehensive weight of each index in the preliminary screening plane zoning indexes is calculated and obtained according to an engineering geological comprehensive zoning model; wherein the engineering geological comprehensive zoning model is a model in which Euclidean distance is introduced to establish a coupled analytic hierarchy process (AHP)-entropy method.

S18: a first engineering geological zoning index number is calculated and obtained by using a geographic information system spatial analysis method and a multi-index superposition method according to the comprehensive weight of each index in the preliminary screening plane zoning indexes; wherein the first engineering geological zoning index number grades the engineering geological conditions into four grades of good, medium, relatively poor and poor.

S19: the preliminary plane engineering geological zoning result is obtained by adopting a natural breakpoint grading method or an expert experience method according to the first engineering geological zoning index number.

After obtaining the preliminary plane engineering geological zoning result, it is necessary to optimize the preliminary plane engineering geological zoning result. Therefore, step S2 specifically includes the following contents.

S21: the preliminary screening plane zoning indexes are randomly arranged and combined as an input layer, and the preliminary plane engineering geological zoning result is taken as the output layer result, they are trained based on the DNN model to obtain the first optimal index combination.

S22: the first optimal index combination is taken as an input layer to perform DNN simulation to predict the results and obtain the final plane engineering geological zoning result.

In an exemplary embodiment, the working area undergoes plane engineering geological zoning of step S1, which includes the following contents.

A1: a plane engineering geological zoning index system is constructed, an engineering geological zoning model is established, and the plane engineering geological zoning is carried out on the working area with the help of the geographic information system.

A2: the model training is performed with the help of machine learning based on the result of the plane engineering geological zoning in step A1 to screen out a zoning key index combination with universal adaptability and high accuracy.

A3: the plane zoning result is optimized based on machine learning according to the key index combination.

The specific steps include the following contents.

Step 1.1: the plane zoning index is determined preliminarily and the index data are collected. With the help of geographic information system ArcGIS software, each of the index data is initially processed, and the working area is divided into several grid units with the same size, that is, each grid unit has the numerical value of each index. The raster in the plane working area is convert into point data based on the raster to point conversion tool, and the data in each zoning index raster file is extracted into the point data by using the multi-value to point extraction tool, the extraction results can be exported to Excel spreadsheets or TXT text data for easy processing and analysis. It is necessary to standardize each of the index data, and analyze the correlation between various indexes based on Pearson correlation coefficient in SPSS software. When the absolute value of the correlation coefficient between two factors is greater than 0.5, it is considered to have a high correlation, and the zoning index can be preliminarily screened.

The plane engineering geological zoning index system is divided into five layers by using the hierarchical method: the overall target layer, the element layer (the first-level index layer), the index layer (the second-level index layer), the index classification layer and the zoning object layer. The target layer is the target of system analysis, which is the engineering geological zoning of the working area; the element layer is the influence factor of the target layer, which can consider the tectonic stability and the surface stability; the index layer is the influence factor of the element layer, which is each factor affecting regional crustal stability; the index classification layer is the numeralization of the abstract concept of the element layer, and is divided and assigned on the basis of the weight calculation of the element layer; and the zoning object layer is the engineering geological zoning result of the target layer region.

The engineering geological comprehensive zoning model based on the coupling of AHP-entropy method is established by introducing the Euclidean distance, and the comprehensive weight of each index is obtained. According to the scores of experts, the judgment matrixes of the zoning element layer and the index layer are constructed respectively. The weight of each index in AHP is calculated by formula (1), and the relative weight of each factor in the judgment matrix is calculated and the consistency test is carried out.

$${W}_{a} = \frac{1}{n} {\sum }_{j = 1}^{n} \frac{{a}_{ij}}{{\sum }_{k = 1}^{n} {a}_{kj}} , i , j = 1 , 2 , … , n ; \qquad ( 1 )$$

Wherein, Wₐ is the weight of each index in AHP, which is the eigenvector (weight coefficient), n is the factor number, i is the row of the factor matrix, j is the column of the factor matrix, aᵢⱼ is the quantitative representation of the relative importance or priority between the index i and the index j, and aₖⱼ is the quantitative representation of the relative importance or priority between the index k and the index j.

Entropy method is used to calculate the objective weight of the factor index. Based on MATLAB software, the decision matrix is standardized, and the index factors are objectively weighted, as shown in formula (2), to calculate the entropy value and difference value of the index and obtain the entropy weight of each index.

$${W}_{b} = \frac{1 + \frac{1}{ln ( n )} * {\sum }_{k = 1}^{n} ( \frac{{X}_{kl}}{{\sum }_{k = 1}^{n} {x}_{kl}} * ln ( \frac{{X}_{kl}}{{\sum }_{k = 1}^{n} {x}_{kl}} ) )}{{\sum }_{l = 1}^{m} ( 1 + \frac{1}{ln ( n )} * {\sum }_{k = 1}^{n} ( \frac{{X}_{kl}}{{\sum }_{k = 1}^{n} {x}_{kl}} * ln ( \frac{{X}_{kl}}{{\sum }_{k = 1}^{n} {x}_{kl}} ) ) )} ; \qquad ( 2 )$$

wherein, W_{b} is the entropy weight of each index, n is the factor number, k is the sample number, l is the index number, and Xₖₗ is the index sample dataset in the study region.

The Euclidean distance is introduced to couple the weights of each index obtained by the AHP and the entropy method to obtain the combined weight, as shown in formula (3).

$$ω = α {W}_{a} + β {W}_{b} ; \qquad ( 3 )$$

wherein, ω is the comprehensive weight of each index, α is the preference degree of the AHP weight of each index, that is, the preference degree of the subjective weight, β is the preference degree of the entropy weight of each index, that is, the preference degree of the objective weight, Wₐ is the AHP weight of each index, W_{b} is the entropy weight of each index.

According to the Euclidean distance function, the difference degree equation is established to determine α and β.

$$D ( {W}_{a} , {W}_{b} ) = \sqrt{\frac{1}{2} {\sum }_{1}^{i} {( {W}_{a} , {W}_{b} )}^{2}} ; \qquad ( 4 )$$

$$D {( {W}_{a} , {W}_{b} )}^{2} = {( α - β )}^{2} ; \qquad ( 5 )$$

$$α + β = 1. \qquad ( 6 )$$

The engineering geological zoning index number (Formula 7) is obtained with the help of the geographic information system spatial analysis method and the multi-index superposition method, the index classification is assigned based on the reclassification tool, and each index map layer is respectively multiplied by the comprehensive weight and superposed by using a raster calculator tool to obtain a result map layer. The plane engineering geological zoning calculation result of the working area is obtained by using the methods of natural breakpoint grading or expert experience. Based on the comprehensive analysis calculation result and the field geological survey data, the engineering geological conditions are graded into four grades: good, medium, relatively poor and poor. The zoning of engineering geological conditions describes the typical engineering geological characteristics and main engineering geological problems within different zones, evaluates and predicts the possibility and the spatial location of the major engineering geological problems, and proposes suggestions for preventing engineering geological problems or suggestions for comparing engineering routes.

$${S}_{1} = \sum {W}_{i} \cdot {P}_{i} ; \qquad ( 7 )$$

wherein, S₁ is the engineering geological zoning index number, Wᵢ is the coupling weight of the AHP-entropy method and Pᵢ is the index number.

Step 1.2: a DNN model is constructed for training based on the torch library of the Python language. The preliminary screening plane zoning indexes are randomly arranged and combined, the number of combinations gradually increases from 1 to all indexes, which are used as input layers respectively. Respectively assign values 1, 2, 3, and 4 to the four grades of good, medium, relatively poor, and poor of the engineering geological conditions of the working area zoning result obtained in step A1 as the output layer results. Neuron is set as 100 and 1 hidden layer, the activation function is Relu, the cross entropy loss function is used, the learning rate is set as 0.01, the ratio of training set to test set is 7:3, and DNN model training is carried out.

According to the result trained by the DNN model, the accuracy, the weighted recall, and the F1 value (comprehensive accuracy and recall) of each group of index combination of the plane zoning are obtained. By sorting and analyzing the above results from high to low, an index combination with universal adaptability and high accuracy can be obtained.

Step 1.3: the optimal index combination obtained in step 1.2 is taken as the input layer to carry out DNN simulation to predict the results, the parameters of the model are kept unchanged, and the obtained simulation results are taken as the final plane engineering geological zoning results of the working area.

As an optional embodiment, step S3 specifically includes the following contents.

S31: the engineering geological condition data of the working area are acquired, wherein the engineering geological condition data of the working area include geological pictures, remote sensing images and geological survey information.

S32: the profile zoning indexes are determined according to the engineering geological condition data of the working area.

S33: the working area is divided into grids to obtain a plurality of second grid units with the same size; wherein each second grid unit has a numerical value corresponding to the profile zoning index.

S34: each second grid unit is standardized to obtain a standardized second unit.

S35: the second correlation between the various profile zoning indexes in the standardized second unit is determined based on the Pearson correlation coefficient in the SPSS software.

S36: the profile zoning indexes with the second correlation greater than the second preset threshold are taken as preliminary screening profile zoning indexes.

S37: the weights of each index in the preliminary screening profile zoning indexes are determined by adopting AHP.

S38: a second engineering geological zoning index number is calculated and obtained by using a geographic information system spatial analysis method and a multi-index superposition method according to the weights of each index in the preliminary screening profile zoning indexes; wherein the second engineering geological zoning index number grades the engineering geological conditions into four grades of good, medium, relatively poor and poor.

S39: the profile engineering geological zoning result is obtained by adopting a natural breakpoint grading method or an expert experience method according to the second engineering geological zoning index number.

Similarly, after obtaining the profile engineering geological zoning result, it is necessary to optimize the profile engineering geological zoning result. Therefore, step S4 specifically includes the following contents.

S41: the preliminary screening profile zoning indexes are randomly arranged and combined as input layers, with the preliminary profile engineering geological zoning result as the output layer result, and trained based on DNN model to obtain the second optimal index combination.

S42: the second optimal index combination is taken as input layer to perform DNN simulation to predict the results and obtain the final profile engineering geological zoning result.

In an exemplary embodiment, the working area undergoes profile engineering geological zoning of step S2, which includes the following contents.

B1: a profile engineering geological zoning index system is constructed, an engineering geological zoning model is established, and profile engineering geological zoning is carried out on the working area with the help of the geographic information system.

B2: the model training is performed with the help of machine learning based on the result of the profile engineering geological zoning in step B1 to screen out a zoning key index combination with universal adaptability and high accuracy.

B3: the profile zoning result is optimized based on machine learning according to the key index combination.

The specific steps include the following contents.

Step 2.1: on the basis of the plane zoning result obtained in step A1, a sectional evaluation map of the profile engineering geological conditions of the recommended route is obtained by taking the engineering design elevation as the baseline for the profile zoning result. The profile engineering geological zoning index system of the key section is established by preliminarily determining the profile zoning index and collecting the index data. The target layer is the profile engineering geological zoning, the element layer can consider the elements such as geological structure, stratum lithology, rock and soil mass characteristics, adverse geological effects, ground temperature and the like, the index layer is various factors affecting the engineering geological conditions, and the index classification layer is the numeralization of abstract concept of the element layer and is divided and assigned on the basis of the weight calculation of the element layer; and the zoning object layer is the profile engineering geological zoning result of the key section.

With the help of geographic information system ArcGIS software, the initial processing of each of the index data of the profile is carried out, the grid division of the working area is carried out in the same way. The index grid within the working area is extracted into the point data by using the multi-value to point extraction tool, the extraction results can be exported to Excel spreadsheets or TXT text data for easy processing and analysis. It is necessary to standardize each of the index data, and analyze the correlation between each index based on Pearson correlation coefficient in SPSS software. When the absolute value of the correlation coefficient between two factors is greater than 0.5, it is considered to have a high correlation, and the profile zoning index can be preliminarily screened.

The weight of the profile engineering geological zoning index is determined by adopting AHP. According to the scores of experts, the judgment matrixes of the zoning element layer and the index layer are constructed respectively, and the weight of profile zoning index is obtained according to the calculation. An engineering geological zoning index number is obtained with the help of the geographic information system spatial analysis method and the multi-index superposition method, the index classification is assigned based on the reclassification tool, and each index map layer is respectively multiplied by the comprehensive weight and superposed by using a raster calculator tool to obtain a result map layer. The profile engineering geological zoning calculation result of the working area is obtained by using the methods of natural breakpoint grading or expert experience. Based on the comprehensive analysis calculation result and the field geological survey data, the engineering geological conditions are zoned into four grades: good, medium, relatively poor and poor.

Step 2.2: a DNN model is constructed for training based on the torch library of the Python language. The preliminary screening profile zoning indexes are randomly arranged and combined, the number of combinations gradually increases from 1 to all indexes, which are used as input layers respectively. Respectively assign values 1, 2, 3, and 4 to the four grades of good, medium, relatively poor, and poor of engineering geological conditions of the working area zoning result obtained in step 1 as the output layer results. Neuron is set as 100 and 1 hidden layer, the activation function is Relu, the cross entropy loss function is used, the learning rate is set as 0.01, the ratio of training set to test set is 7:3, and DNN model training is carried out.

According to the result trained by the DNN model, the accuracy, the weighted recall, and the F1 value (comprehensive accuracy and recall) of each group of index combination of the profile zoning are obtained. By sorting and analyzing the above results from high to low, an index combination with universal adaptability and high accuracy can be obtained.

Step 2.3: the optimal index combination obtained in step 2.2 is taken as the input layer to carry out DNN simulation to predict the results, the parameters of the model are kept unchanged, and the obtained simulation results are taken as the final profile engineering geological zoning results of the working area.

As an optional embodiment, step S5 specifically includes the following contents.

S51: the final plane engineering geological zoning result and the final profile engineering geological zoning result are smoothed to obtain a smoothed plane engineering geological zoning result and a smoothed profile engineering geological zoning result.

S52: the smoothed profile engineering geological zoning result is extracted in the form of points based on ArcGIS software, the points correspond to the smoothed plane engineering geological zoning result one by one, and the generated engineering geological zoning result of the region through which the profile railway line passes is converted into a plane expression by using Kriging interpolation.

S53: the engineering geological conditions of the plane expression is determined according to the smoothed profile engineering geological zoning result to obtain a planarized profile zoning result.

S54: the planarized profile zoning result and the smoothed plane engineering geological zoning result are superposed by using a mosaic to new raster tool to obtain a plane-profile combined zoning result of the key section.

S55: the plane-profile combined zoning result of the key section is smoothed and optimized base on a focus statistical tool in ArcGIS software to obtain the linear engineering geological tridimensional zoning image.

In an exemplary embodiment, in step S3, the final plane engineering geological zoning result is combined with the final profile engineering geological zoning result, including the following contents.

C1: the optimized plane engineering geological zoning result obtained in step 1 and the optimized profile engineering geological zoning result obtained in step 2 are smoothed.

C2: combining the plane and profile zoning results optimized in step 1.

C3: optimizing and smoothing the division result image.

The specific steps include the following contents.

Step 3.1: the optimized plane engineering geological zoning result obtained in step 1 and the optimized profile engineering geological zoning result obtained in step 2 are smoothed. The plane result and the profile result are smoothed respectively based on the focus statistical tool in ArcGIS software, the statistical type is MAJORITY

Step 3.2: Based on ArcGIS software, extract the smoothed profile engineering geological zoning result is extracted in the form of points according to the width of both sides of the engineering line to be further compared and optimized, which is not less than 1 km, the points correspond to the plane one by one, and the generated engineering geological zoning result of the region through which the profile railway line passes is converted into a plane expression by using Kriging interpolation. According to the profile engineering geological zoning result, the plane expression is graded into good, medium, relatively poor and poor engineering geological conditions, and the planarized profile zoning result and the plane zoning result are superposed by using a mosaic to new raster tool to obtain a plane-profile combined zoning result of the key section; wherein MAXIMUM is selected as the mosaic operator, that is, the principle of “high not low”.

Step 3.3: the raster data of the tridimensional zoning result map obtained in step 3.2 is smoothed. Based on the focus statistical tool in ArcGIS software, and the final linear engineering geological tridimensional zoning image can be obtained by smoothing and optimizing the result; wherein the statistical type is MAJORITY

The present disclosure proposes methods for linear engineering geological zoning index optimization and engineering geological tridimensional zoning result optimization based on a geographic information system and machine learning, selects the key indexes of engineering geological plane zoning and engineering geological profile zoning of the long and large linear project in complex mountainous region, and establishes the optimization index system respectively. The present disclosure provides the engineering geological tridimensional zoning result formed by fusing the engineering geological plane zoning result and the profile segmented result and the detailed steps for optimizing the engineering geological tridimensional zoning result, the disaster-pregnant background of the linear engineering geological problem and the control effect of the disaster-pregnant background on the engineering geological condition can be more intuitively known, so that the prevention and control of linear engineering geological risks considering the layout of both the surface engineering and the underground engineering can be scientifically guided.

The present disclosure also provides an application scenario in which the linear engineering geological tridimensional zoning method is applied. Specifically, the linear engineering geological tridimensional zoning method provided in this embodiment can be applied to a linear engineering geological tridimensional zoning scenario. The linear engineering geological tridimensional zoning scenario includes a plane engineering geological zoning link, a plane engineering geological zoning result optimization link, a profile engineering geological zoning link, a profile engineering geological zoning result optimization link and a combination link. Firstly, the working area undergoes plane engineering geological zoning to obtain a preliminary plane engineering geological zoning result, wherein the preliminary plane engineering geological zoning result is a result obtained based on a plane zoning index; secondly, the preliminary plane engineering geological zoning result is optimized to obtain a final plane engineering geological zoning result; then the working area undergoes profile engineering geological zoning to obtain a preliminary profile engineering geological zoning result, wherein the preliminary profile engineering geological zoning result is a result obtained based on a profile zoning index; and again the preliminary profile engineering geological zoning result is optimized to obtain a final profile engineering geological zoning result; finally, the final plane engineering geological zoning result is combined with the final profile engineering geological zoning result to obtain a linear engineering geological tridimensional zoning image.

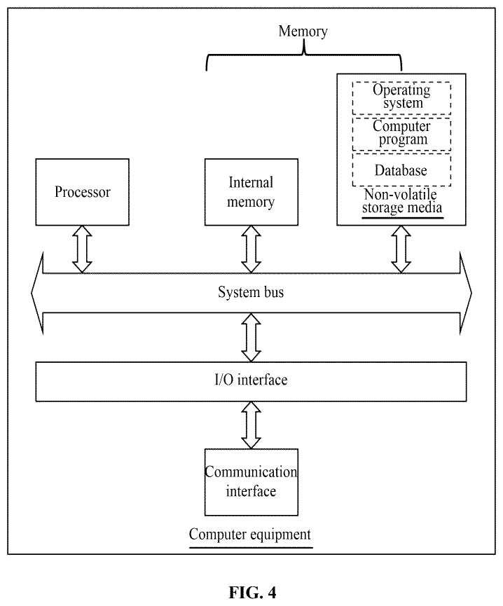

In an exemplary embodiment, a computer equipment is provided, which can be a server or a terminal, and its internal structure diagram can be shown in FIG. 4. The computer equipment includes a processor, a memory, an Input/Output interface (I/O), and a communication interface. Wherein, the processor, the memory, and the input/output interface are connected through the system bus, and the communication interface is connected to the system bus through the I/O interface. Wherein, the processor of the computer equipment is used to provide computing and control capabilities. The memory of the computer equipment includes a non-volatile storage medium and an internal memory. This non-volatile storage medium stores operating systems, computer programs, and databases. The internal memory provides an environment for the operation of operating systems and computer programs in non-volatile storage media. The database of the computer equipment is used to store the working area. The I/O interface of the computer equipment is used for exchanging information between the processor and the external equipment. The communication interface of the computer equipment is used to communicate with the external terminals through a network connection. The computer program is executed by the processor to implement a method for linear engineering geological tridimensional zoning.

Those of skill in the art can understand that the structure shown in FIG. 4 is only a block diagram of a part of the structure related to the present disclosure, and does not constitute a limitation on the computer equipment to which the present disclosure is applied. The specific computer equipment may include more or fewer components than shown in the figure, or combine certain components, or have different component arrangements. In an exemplary embodiment, a computer equipment is provided, including a memory and a processor, wherein the memory stores a computer program, and the processor executes the computer program to implement the steps of the above method embodiments.

In an exemplary embodiment, a computer equipment is provided which includes a memory and a processor, wherein the memory stores a computer program, and the processor realizes the method embodiments when executing the computer program.

In an exemplary embodiment, a computer-readable storage medium is provided which stores a computer program, the steps in the above method embodiments are implemented if the computer program is executed by the processor.

It should be noted that the user information (including but not limited to user equipment information, user personal information, etc.) and data (including but not limited to data used for analysis, stored data, displayed data, etc.) involved in the present disclosure are all authorized by the user or fully authorized by all parties, and the collection, the use, and the processing of the relevant data must comply with relevant regulations.

Those of ordinary skill in the art can understand that implementing all or part of the processes in the above embodiments can be accomplished by instructing relevant hardware through a computer program. The computer program can be stored in a non-volatile computer-readable storage medium, and if executed, it can include the processes of the embodiments of the above methods. Wherein, any reference to the memory, the database, or other media used in the embodiments provided in the present disclosure may include at least one of the non-volatile memory and the volatile memory. The non-volatile memory can include a Read-Only Memory (ROM), a magnetic tape, a floppy disk, a flash memory, an optical memory, a high-density embedded non-volatile memory, a Resistive Random Access Memory (ReRAM), a Magnetoresistive Random Access Memory (MRAM), a Ferroelectric Random Access Memory (FRAM), a Phase Change Memory (PCM), a graphene memory, etc. The volatile memory can include a Random Access Memory (RAM) or an external cache memory, etc. As an illustration and not a limitation, RAM can take various forms, such as a Static Random Access Memory (SRAM) or a Dynamic Random Access Memory (DRAM).

The databases involved in the various embodiments provided in the present disclosure may include at least one of relational databases and non-relational databases. Non-relational databases may include distributed databases based on blockchain, but are not limited to these. The processors involved in the various embodiments provided in the present disclosure may be general-purpose processors, central processing units, graphics processors, digital signal processors, programmable logic units, quantum computing based data processing logic units, etc., but are not limited to these.

The various technical features of the above embodiments can be combined arbitrarily. In order to make the description concise, not all possible combinations of the various technical features in the above embodiments have been described. However, as long as there is no contradiction in the combination of these technical features, they should be considered within the scope of the present specification.

The present disclosure uses specific examples to explain the principles and implementation methods, and the above examples are only used to help understand the method and the core idea of the present disclosure. Meanwhile, for those of ordinary skill in the art, there may be changes in the specific implementation methods and application scope based on the ideas of the present disclosure. In summary, the content of the present specification should not be construed as limiting the present disclosure.

What is claimed is:

1. A method for linear engineering geological tridimensional zoning, comprising
carrying out plane engineering geological zoning on a working area is to obtain a preliminary plane engineering geological zoning result; wherein the preliminary plane engineering geological zoning result is a result obtained based on a plane zoning index;
optimizing the preliminary plane engineering geological zoning result to obtain a final plane engineering geological zoning result;
carrying out profile engineering geological zoning on the working area to obtain a preliminary profile engineering geological zoning result; wherein the preliminary profile engineering geological zoning result is a result obtained based on a profile zoning index;
optimizing the preliminary profile engineering geological zoning result to obtain a final profile engineering geological zoning result; and
combining the final plane engineering geological zoning result and the final profile engineering geological zoning result to obtain a linear engineering geological tridimensional zoning image.

2. The method for linear engineering geological tridimensional zoning according to claim 1, wherein the carrying out plane engineering geological zoning on a working area is to obtain a preliminary plane engineering geological zoning result comprises:
acquiring engineering geological condition data of the working area; wherein the engineering geological condition data of the working area comprises geological pictures, remote sensing images and geological survey information;
determining plane zoning indexes according to the engineering geological condition data of the working area;
dividing the working area into grids to obtain a plurality of first grid units with a same size; wherein each first grid unit has a numerical value corresponding to the plane zoning index;
carrying out standardization processing on each first grid unit to obtain a standardized first unit;
determining a first correlation between various plane zoning indexes in the standardized first unit based on Pearson correlation coefficient in an SPSS software;
taking a plane zoning index of which the first correlation is greater than a first preset threshold as preliminary screening plane zoning indexes;
calculating and obtaining a comprehensive weight of each index in the preliminary screening plane zoning indexes according to an engineering geological comprehensive zoning model; wherein the engineering geological comprehensive zoning model is a model in which Euclidean distance is introduced to establish a coupled analytic hierarchy process (AHP)-entropy method;
calculating and obtaining a first engineering geological zoning index number by using a geographic information system spatial analysis method and a multi-index superposition method according to the comprehensive weight of each index in the preliminary screening plane zoning indexes; wherein the first engineering geological zoning index number grades the engineering geological conditions into four grades of good, medium, relatively poor and poor; and
obtaining the preliminary plane engineering geological zoning result by adopting a natural breakpoint grading method or an expert experience method according to the first engineering geological zoning index number.

3. The method for linear engineering geological tridimensional zoning according to claim 2, wherein the optimizing the preliminary plane engineering geological zoning result to obtain a final plane engineering geological zoning result comprises:
carrying out random permutation and combination on the preliminary screening plane zoning indexes as input layers, with the preliminary plane engineering geological zoning result as an output layer result, and carrying out training based on a DNN model to obtain a first optimal index combination; and
taking the first optimal index combination as input layers to perform DNN simulation to predict results and obtaining the final plane engineering geological zoning result.

4. The method for linear engineering geological tridimensional zoning according to claim 2, wherein a calculation formula of the comprehensive weight of each index is
$$ω = α {W}_{a} + β {W}_{b} ;$$
wherein, ω is the comprehensive weight of each index, α is a preference degree of an AHP weight of each index, β is a preference degree of an entropy weight of each index, Wₐ is an AHP weight of each index, W_{b} is an entropy weight of each index.

5. The method for linear engineering geological tridimensional zoning according to claim 2, wherein a calculation formula of the engineering geological zoning index number is
$${S}_{1} = \sum {W}_{i} \cdot {P}_{i} ;$$
wherein, S₁ is the engineering geological zoning index number, Wᵢ is a coupling weight of the AHP-entropy method and Pᵢ is an index number.

6. The method for linear engineering geological tridimensional zoning according to claim 1, wherein the carrying out profile engineering geological zoning on a working area is to obtain a preliminary profile engineering geological zoning result comprises:
acquiring engineering geological condition data of the working area; wherein the engineering geological condition data of the working area comprises geological pictures, remote sensing images and geological survey information;
determining profile zoning indexes according to the engineering geological condition data of the working area;
dividing the working area into grids to obtain a plurality of second grid units with a same size; wherein each second grid unit has a numerical value corresponding to the profile zoning index;
carrying out standardization processing on each second grid unit to obtain a standardized second unit;
determining a second correlation between various profile zoning indexes in the standardized second unit based on Pearson correlation coefficient in an SPSS software;
taking a profile zoning index of which the second correlation is greater than a second preset threshold as preliminary screening profile zoning indexes;
determining weights of each index in the preliminary screening profile zoning indexes by adopting an AHP;
calculating and obtaining a second engineering geological zoning index number by using a geographic information system spatial analysis method and a multi-index superposition method according to the weight of each index in the preliminary screening profile zoning indexes; wherein the second engineering geological zoning index number grades the engineering geological conditions into four grades of good, medium, relatively poor and poor; and
obtaining the preliminary profile engineering geological zoning result by adopting a natural breakpoint grading method or an expert experience method according to the second engineering geological zoning index number.

7. The method for linear engineering geological tridimensional zoning according to claim 6, wherein the optimizing the preliminary profile engineering geological zoning result to obtain a final profile engineering geological zoning result comprises:
carrying out random permutation and combination on the preliminary screening profile zoning indexes as input layers, with the preliminary profile engineering geological zoning result as an output layer result, and carrying out training based on a DNN model to obtain a second optimal index combination; and
taking the second optimal index combination as input layers to perform DNN simulation to predict results and obtaining the final profile engineering geological zoning result.

8. The method for linear engineering geological tridimensional zoning according to claim 1, wherein the combining the final plane engineering geological zoning result and the final profile engineering geological zoning result to obtain a linear engineering geological tridimensional zoning image comprises:
smoothing the final plane engineering geological zoning result and the final profile engineering geological zoning result to obtain a smoothed plane engineering geological zoning result and a smoothed profile engineering geological zoning result;
extracting the smoothed profile engineering geological zoning result in a form of points based on ArcGIS software, enabling the points correspond to the smoothed plane engineering geological zoning result one by one, and converting a generated engineering geological zoning result of the region through which a profile railway line passes into a plane expression by using Kriging interpolation;
determining engineering geological conditions of the plane expression according to the smoothed profile engineering geological zoning result to obtain a planarized profile zoning result;
superposing the planarized profile zoning result and the smoothed plane engineering geological zoning result by using a mosaic to new raster tool to obtain a plane-profile combined zoning result of a key section; and
smoothing and optimizing the plane-profile combined zoning result of the key section is based on a focus statistical tool in the ArcGIS software to obtain the linear engineering geological tridimensional zoning image.

9. A computer equipment comprising a memory, a processor, and a computer program stored in the memory and operable on the processor, wherein the processor executes the computer program to implement the method for linear engineering geological tridimensional zoning.

10. A computer readable storage medium on which a computer program is stored, wherein when the computer program is executed by a processor, the method for linear engineering geological tridimensional zoning is realized.
